(19) United States
(12) Patent Application Publication
(10) Pub. No.: US 2020/0134536 A1
(43) Pub. Date: Apr. 30, 2020

(54) AN AUTOMATED SYSTEM FOR PROVIDING PERSONALIZED REWARDS AND A METHOD THEREOF

(71) Applicant: CYBAGE SOFTWARE PRIVATE LIMITED, Pune (IN)

(72) Inventor: Arun Vijay NATHANI, Pune, Maharashtra (IN)

(21) Appl. No.: 16/630,382

(22) PCT Filed: Jul. 24, 2018
(86) PCT No.: PCT/IB2018/055487

§ 371 Date: Jan. 10, 2020

(30) Foreign Application Priority Data
Jul. 25, 2017 (IN) 201721026422

(51) Int. Cl. G06Q 10/06; G06Q 10/10; G06F 16/23

(52) U.S. Cl. CPC G06Q 10/06398; G06F 16/2365; G06Q 10/1057

(57) ABSTRACT

The present disclosure relates to the field of automated rewarding systems. The system comprises a plurality of set of user devices (10) associated with employees, a plurality of second user devices (20) associated with managers, and a server (30). The server (30) is configured to receive peer score values and the manager score values from the set of user devices (10) and second user devices (20). Further, the server (30) is configured to validate the recognitions/ranking provided by the manager by comparing the manager score values with peer score values. Upon successfully validating the recognition/ranking, the server allows the recognized employee to select a reward from a reward catalog, thereby maintaining a competitive environment within a team and keeping the employees of the team motivated.

### FIELD

The present disclosure relates to the field of automated reward providing systems.

### Definitions

As used in the present disclosure, the following terms are generally intended to have the meaning as set forth below, except to the extent that the context in which they are used indicates otherwise.

The expression ‘user’ used hereinafter in the specification refers to an employee of an organization/establishment, using the system of the present disclosure.

The expression ‘user device’ used hereinafter in the specification refers to a device, used by the user, wherein the user device includes, but is not limited to a mobile phone, a laptop, a tablet, a PDA, a notebook, a net book, a smart device, a smart phone, a personal computer, and the like.

The expression ‘organization’ used hereinafter in the specification refers to an entity comprising multiple employees (users), working towards a collective goal.

These definitions are in addition to those expressed in the art.

### BACKGROUND

The background information herein below relates to the present disclosure but is not necessarily prior art.

Organizations generally give gifts/rewards to employees to improve mutual engagement, identify and appreciate their hard work, and to motivate them. Conventional rewarding/gifting techniques within organizations include giving random items as gifts, like decorative items, sweets, coupons/vouchers, and the like. In this case, since the rewarding/gifting is subjective and based on the organization's choice, employee can be less than thrilled to receive the items/coupons which he/she may not be in need of. For example, some organizations distribute confectioneries as gifts during festivals like Diwali/Dussehra, which may not appeal to a diabetic or health conscious employee. Further, the vouchers/coupons provided to him may never be used if the employee is not interested in the service that can be availed with the help of those vouchers/coupons. Moreover, such types of gifting techniques are private and provide limited or no recognition to the employee within his peers/superiors.

Additionally, motivated teams always perform better however it's always a challenge to keep the team motivated. Modern workplaces are dominated by millennials and workforce that seek motivation not only from monetary gains but from a sense of engagement and belonging. Organizations that actively ‘listen’ to what they have to say promotes employee engagement, fostering deeper connect with the organization.

Conventional systems fail to provide a platform that enables the managers to instantly reward the individual and the team for their performance or for achieving a project goal which invariably inculcates a sense of achievement in employees.

Therefore, to limit the aforementioned drawbacks of the conventional rewarding systems, the present disclosure envisages a system and method that provides unbiased and personalized rewards.

### OBJECTS

Some of the objects of the present disclosure, which at least one embodiment herein satisfies, are as follows:

An object of the present disclosure is to provide an automated system which facilitates employees to choose their rewards.

Another object of the present disclosure is to provide an automated system which facilitates objective ranking which limits biased recognition.

Another object of the present disclosure is to provide an automated system which facilitates the delivery of a chosen reward to a desired location.

Yet another object of the present disclosure is to provide an automated system which facilitates the employees to exchange their reward.

Other objects and advantages of the present disclosure will be more apparent from the following description, which is not intended to limit the scope of the present disclosure.

### SUMMARY

The present disclosure envisages an automated system for providing personalized rewards. The system includes a plurality of set of user devices, a plurality of second user devices, and a server.

Each of the set of user devices is associated with a team of employees of an organization. Further, each of the set of user devices is being configured to facilitate an employee of the associated team to provide at least one peer score value for each of the employees of the associated team.

Each of the second user devices is associated with a manager of each team. Further, each of the second user devices is being configured to facilitate the associated manager to provide a manager score value for each of the employees of the associated team respectively.

The server includes a memory, a ranking unit, an assessment unit, a validation unit, an autocorrection unit, and a reward engine, and is configured to cooperate with the plurality of set of user devices and the plurality of second user devices.

The memory is configured to store a set of pre-defined organization rules, a first lookup table having a list of employees and employee details, computed historical score values, team details, corresponding to each of the listed employees, and a second lookup table having a list of pre-determined rank values and a reward catalog corresponding to each of the pre-determined rank values.

The ranking unit is configured to cooperate with the memory, and is further configured to generate a rating value for each of the employees based on the peer score values. In an embodiment, the ranking unit is configured to compute the rating value for each of the employees of the associated team by averaging the peer score values provided by the employees of the associated team for each of the employees.

The assessment unit is configured to cooperate with the ranking unit, and is further configured to generate a rank value for each of the employees of the team based on the rating values received from the ranking unit. Further, the validation unit is configured to cooperate with the assessment unit, and is further configured to identify errors or an occurrence of biasness by comparing the rank value of each employee with the manager score values.

The autocorrection unit is configured to cooperate with the validation unit, the ranking unit and the memory. The autocorrection unit is configured to autocorrect the identified errors or biasness by correcting the manager score values using the computed historical score values, the rating values computed using peer score values, and the set of pre-defined rules.

In an embodiment, the autocorrection unit comprises an updater and a flag generator. The updater is configured to cooperate with the validation unit, and is further configured to autocorrect the identified error by updating the manager score values using the computed historical score values, the rating values computed using the peer score values, and the set of pre-defined rules. The flag generator is configured to cooperate with the updater, and is further configured to generate a flag to indicate autocorrection of the manager score values. The flag generator and the updater of the autocorrection unit are configured to be implemented using one or more processor(s).

The reward engine is configured to cooperate with the memory and the assessment unit, and is further configured to extract the reward catalog from the second lookup table corresponding to the generated rank value of each of the employees. Further, the reward engine is configured to facilitate the employees to select a reward from the extracted catalog.

The ranking unit, the assessment unit, the validation unit, the autocorrection unit, and the reward engine are configured to be implemented using one or more processor(s).

In an embodiment, the set of pre-determined parameters is selected from the group consisting of on-time project deliverables, discipline, attentiveness, punctuality, obedience to an organization policies, technical knowledge, productivity, and quality of work.

In an embodiment, the validation unit is configured to generate an alert if biasness or error is identified.

In another embodiment, the validation unit comprises a comparator and an identifier. The comparator is configured to compare the rank value of each employee, generated based on the peer score values, with the manager score values. The identifier is configured to cooperate with the comparator, and is further configured to identify errors or biasness in the manager score values based on the comparison of the rank value of each employee with the manager score values. The comparator and the identifier are configured to be implemented using one or more processor(s).

In an embodiment, the reward catalog contains rewards selected from the group consisting of gift vouchers, merchandise, cash coupons, sweets, chocolates, and e-vouchers.

In another embodiment, the server includes a communication module. The communication module is configured to cooperate with the reward engine to receive and transmit the extracted reward catalog to a user device associated with the employee.

In still another embodiment, the server includes a dispatching unit. The dispatching unit is configured to cooperate with the memory and the reward engine, and is further configured to dispatch the selected reward to a desired address of the employee.

The present disclosure also envisages a method for providing personalized rewards.

### BRIEF DESCRIPTION OF THE ACCOMPANYING DRAWING

The automated system and method for providing rewards, of the present disclosure, will now be described with the help of the accompanying drawing, in which:

FIG. 1 illustrates a block diagram of an automated system for providing personalized rewards; and

FIG. 2a and FIG. 2b illustrate a flow diagram showing the steps performed by the system of FIG. 1.

### LIST OF REFERENCE NUMERALS

100—System
10—Plurality of set of user devices
20—Plurality of second user devices
30—Server
102—Memory
106—Ranking unit
108—Assessment unit
110—Validation unit
110a—Comparator
110b—Identifier
111—Autocorrection unit
111a—Updater
111b—Flag generator
112—Reward engine
114—Dispatching unit
116—Communication module

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise.

The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on,” “engaged to,” “connected to,” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third, etc., when used herein do not imply a specific sequence or order unless clearly suggested by the present disclosure.

Terms such as “inner,” “outer,” “beneath,” “below,” “lower,” “above,” “upper,” and the like, may be used in the present disclosure to describe relationships between different elements as depicted from the figures.

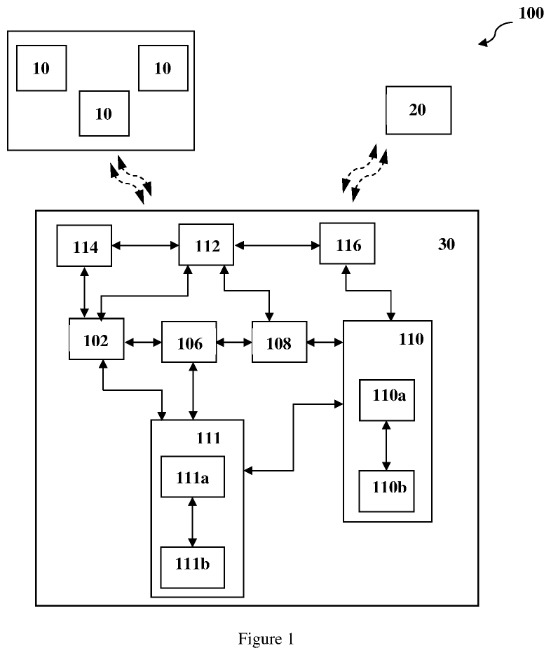

The present disclosure envisages an automated system for providing personalized rewards. An automated system (100) for providing rewards is described with reference to FIG. 1 of the accompanying drawing.

FIG. 1 illustrates a block diagram of the automated system 100 (hereinafter referred as “system”).

The system (100) includes a plurality of set of user devices (10), a plurality of second user devices (20), and a server (30).

Each of the set of user devices (10) is associated with a team of employees of an organization. Further, each of the set of user devices (10) is being configured to facilitate an employee of the associated team to provide at least one peer score value for each of the employees of the associated team based on a set of pre-determined parameters.

Each of the second user devices (20) is associated with a manager of each team. Further, each of the second user devices (20) is being configured to facilitate the associated manager to provide a manager score value for each of the employees of the associated team respectively based on the set of pre-determined parameters. In an embodiment, the manager score values are equivalent to ranking provided by the manager to employees considering the set of pre-determined parameters.

In an embodiment, the set of user devices (10) and the plurality of second user devices (20) include, but is not limited, to a mobile phone, a laptop, a tablet, an iPad, a PDA, a notebook, a net book, a smart device, a smart phone, a personal computer, and the like. In another embodiment, the set of user devices (10) and the second user devices (20) are electronic devices having communication capabilities.

In an embodiment, the set of user devices (10) and the second user devices (20) are configured to communicate with the server (30) via a wireless communication technique or a wired communication technique.

In still another embodiment, the set of pre-determined parameters is selected from the group consisting of on-time project deliverables, discipline, attentiveness, punctuality, obedience to an organization policies, technical knowledge, productivity, and quality of work.

In an embodiment, the plurality of set of user devices (10) and the plurality of second user devices (20) are provided with a graphical user interface respectively so as to facilitate the employees and the managers to provide peer score values and manager score values respectively.

The server (30) includes a memory (102), a ranking unit (106), an assessment unit (108), a validation unit (110), an autocorrection unit (111), and a reward engine (112). The server (30) is configured to cooperate with the plurality of set of user devices (10) and the plurality of second user devices (20).

The memory (102) is configured to store a set of pre-defined organization rules, a first lookup table having a list of employees and employee details, computed historical score values, team details corresponding to each of the listed employees, and a second lookup table having a list of pre-determined rank values and a reward catalog corresponding to each of the pre-determined rank values.

The memory (102) includes any computer-readable medium known in the art including, for example, volatile memory, such as static random access memory (SRAM) and dynamic random access memory (DRAM), and/or a non-volatile memory, such as read only memory (ROM), erasable programmable ROM, flash memories, hard disks, optical disks, and magnetic tapes.

The ranking unit (106) is configured to cooperate with the memory (102), and is configured to generate a rating value for each of the employees based on the received peer score values. In an embodiment, the ranking unit (106) is configured to compute the rating value for each of the employees of the associated team by averaging the peer score values provided by the employees of the associated team for each of the employees.

The assessment unit (108) is configured to cooperate with the ranking unit (106), and is further configured to generate a rank value for each of the employees of the team based on the rating values received from the ranking unit (106). Further, the validation unit (110) is configured to cooperate with the assessment unit (108), and is further configured to identify errors or an occurrence of biasness by comparing the rank value of each employee with the manager score values.

In an embodiment, the validation unit (110) is also configured to identify errors or occurrence of business if a particular employee is being repeatedly recognized or given high score values by a particular manager. In another embodiment, the validation unit (110) is configured to generate an alert upon identifying occurrence of biasness or error. The validation unit (110) is configured to generate the alert so as to notify the reporting authority or Human Resource manager about such instances thereby allowing the reporting authority or the Human Resource manager to take the appropriate measure.

In another embodiment, the validation unit (110) comprises a comparator (110a) and an identifier (110b). The comparator (110a) is configured to compare the rank value of each employee, generated based on the peer score values, with the manager score values. The identifier (110b) is configured to cooperate with the comparator (110a), and is further configured to identify errors or biasness in the manager score values based on the comparison of the rank value of each employee with the manager score values. The comparator (110a) and the identifier (110b) are configured to be implemented using one or more processor(s).

The autocorrection unit (111) is configured to cooperate with the validation unit (110), the ranking unit (106) and the memory (102). The autocorrection unit (111) is configured to autocorrect the identified errors or biasness by correcting the manager score values using the computed historical score values, set of pre-determined parameters, the rating values computed using peer score values, and the set of pre-defined rules.

In an embodiment, the autocorrection unit (111) comprises an updater (111a) and a flag generator (111b). The updater (111a) is configured to cooperate with the validation unit (110), and is further configured to autocorrect said identified error by updating the manager score values using the computed historical score values, the rating values computed using the peer score values, and the set of pre-defined rules. The flag generator (111b) is configured to cooperate with the updater (111a), and is further configured to generate a flag to indicate autocorrection of the manager score values. The flag generator (111b) and the updater (111a) of the autocorrection unit (111) are configured to be implemented using one or more processor(s).

The reward engine (112) is configured to cooperate with the memory (102) and the assessment unit (108), and is further configured to extract the reward catalog from the second lookup table corresponding to the generated rank value of each of the employees. Further, the reward engine is configured to facilitate the employees to select a reward from the extracted catalog.

The ranking unit (106), the assessment unit (108), the validation unit (110), the autocorrection unit (111), and the reward engine (112) are configured to be implemented using one or more processor(s).

In an embodiment, the reward catalog contains rewards selected from the group consisting of gift vouchers, merchandise, cash coupons, sweets, chocolates, and e-vouchers.

In another embodiment, the server (30) includes a communication module (116). The communication module (116) is configured to cooperate with the reward engine (112) to receive and transmit the extracted reward catalog to a user device associated with the employee.

In an embodiment, the second user device (20) associated with the manager is configured to facilitate the manager to provide details of employees to be rewarded from the associated team. Further, the validation unit (110) will then validate the provided list of employees to be rewarded based on the rank values generated by peer score values.

In another embodiment, the validation unit (110) is also configured to detect under recognitions and/or over recognitions given by the managers.

A pseudo code for depicting functionalities of the server (30) for validating the rewards being provided to recognized/top performing employees is depicted below.

Step 1: Pick total no. of recognition in team (excluding manager's recognition)

Step 2: Calculate the individual recognition performance according to team as:

Individual recognition performance according to team=(total recognition received by individual in team/total recognition made in team)*100;

Step 3: Pick total no. of recognition made by manager in team.

Step 4: Calculate the individual recognition performance according to manager as:

Individual recognition performance according to manager=(total no. of manager's recognition made for particular individual/total no. of manager's recognition made in team)*100;

Step 5: calculate the manager recognition performance for duration N by taking difference between “Individual recognition performance according to team” and “Individual recognition performance according to manager” as:

More recognition given by manager (%): (difference between “Individual recognition performance according to team” and “Individual recognition performance according to manager”/Individual recognition performance according to manager)*100

Less recognition given by manager (%): (difference between “Individual recognition performance according to team” and “Individual recognition performance according to manager”/Individual recognition performance according to team)*100

Step 6: For the first time, if “More recognition given by manager (%)” and “Less recognition given by manager (%)” exceeds the “P” range then we report manager performance according to range.

Step 7: We compare previous duration and current duration's manager recognition performance for particular individual based on “More recognition given by manager (%)” and “Less recognition given by manager (%)” and if the difference is exceeding “P” range then we report manager performance according to range.

In one embodiment, the user details stored within the first lookup table includes desired delivery address as preferred by the users, designation of the users, personal details including birthdates, anniversaries, joining date, and the like.

In still another embodiment, the server includes a dispatching unit (114). The dispatching unit (114) is configured to cooperate with the memory (102) and the reward engine (112), and is further configured to dispatch the selected reward to a delivery address desired by the employee.

In an embodiment, the system (100) of the present disclosure is also configured to facilitate the employees to select a reward from the reward catalog on occasions such as employee's birthday, marriage anniversary, work anniversary, firm's anniversary, festive occasions, and the like based on the performance, experience, and designation of the employees.

The processor is configured to cooperate with the memory to receive and process the set of pre-determined rules to obtain a set of system operating commands. The processor may be implemented as one or more microprocessors, microcomputers, microcontrollers, digital signal processors, central processing units, state machines, logic circuitries, and/or any devices that manipulate signals based on operational instructions. Among other capabilities, the processor is configured to fetch and execute the set of predetermined rules stored in the memory to control units/engine of the system (100).

A pseudo code for depicting functionalities of the server (30) for rewarding employees of the organization is depicted below.

Distribution of Reward by Dispatching Unit:

Begin
Step 1: Pick all Employees with upcoming birthdays and/or Anniversaries.
Step 2: Pick a voucher depending on employee's gender, seniority, location, designation etc.
Step 3: Check employee's leaves schedule on his/her birthday and/or Anniversary.
Step 4: Check whether the employee is absent or present, on voucher distribution day.
Step 5: Distribute voucher for all employees whenever employee is available.
   Vouchers are distributed as:

Set A=Get all employees with upcoming birthdays and anniversaries+Set C.

Set B=Find available employees from Set A.

Set C=Set A−Set B
Distribute vouchers to Set B.
Step 6: Expiry of voucher will be extended according to voucher distribution day.
Step 7: At the time of voucher redemption we give Product Suggestion is based on:
Begin
   Step 7.1: Pick all past history of employee (Who is having birthdays and/or Anniversaries) of what he wants to buy or like.
   Step 7.2: Products can be suggested based on the past search history of employee (Who is having birthdays and/or Anniversaries) on the search pattern like category, price range, brands, color, etc.
   End

End

Birthday/Anniversary Wish Module

Begin
Step 1: Pick all upcoming birthdays and/or Anniversaries of Employees.
Step 2: Pick all information about employees like location, gender, designation etc.
Step 3: Create birthday wish mail/alerts for them on birthdays and/or Anniversaries day.
Step 4: Create birthdays and/or Anniversaries wish mail/alert for wisher who wants to buy gift for them.
Step 5: Selection criteria for wisher:
   1) Pick all employee (E_{by}) who are recognized by individual (who is having birthday and anniversary).
   2) Pick all employee (Eₜₒ) who are recognized to individual (who is having birthday and anniversary).
   3) Get intersection of E_{by} and Eₜₒ.

Eₛₑₜ₁=E_{by}∩Eₜₒ
4) Pick N employees from E_{by} recognition frequency of individual (who is having birthday and anniversary) is greater than P range.

Eₛₑₜ₂=N−Eₛₑₜ₁
Pick M employees from Eₜₒ recognition frequency of individual (who is having birthday and anniversary) is greater than Q range.

Eₛₑₜ₃−M−Eₛₑₜ₁
5) Set mail/alert to Eₛₑₜ₁, Eₛₑₜ₂, Eₛₑₜ₃.
Step 6: Sends mail/alert for wisher N days before birthdays and/or Anniversaries. Which contain Product Suggestion for respective employee.
Step 7: Product Suggestion is based on:
   Begin
      Step 1: Pick all past history of employee (Who is having birthdays and/or Anniversaries) of what he wants to buy or like.
      Step 2: Sends above information to wisher so that they can plan gift for them.
      Step 3: Products can be suggested based on the past search history of employee (Who is having birthdays and/or Anniversaries) on the search pattern like category, price range, brands, color, etc.
   End

End

The system (100) of the present disclosure maintains a competitive environment within a team and keeps the employees of the team motivated. The system (100) provides a platform to the managers to instantly reward individual team members for their exceptional performances, efforts, or for achieving a desired goal which invariably inculcates a sense of achievement in employees.

In an embodiment, the system (100) allows the managers to recognize or score individual team members, teams, departments, and the like. In another embodiment, the managers are provided with a specific number of reward points which are to be distributed between the employees of the associated teams.

The below mentioned cases depict the scenarios where the system (100) of the present disclosure plays a vital role:

Case 1: Identification of Candidates Deserving Recognition

In today's world of instant gratification, delayed recognition is equivalent to denied recognition which leads to demotivated employees. In large organizations, human resource team cannot identify candidates/employees who deserve recognition but are not duly rewarded by their managers. The system of the present disclosure analyses the recognition data and recognition trends and provides a recognition parity index which helps in identifying such deserving employees. The human resource team can take corrective actions using this data and can avoid employee demotivation and thus employee churn. Parity index also helps in zeroing down anomalies in recognition flow in the organization and corrective timely action can be taken.

Case 2: Identify Nepotism

The present system (100) processes recognition data at project, department and company level. It provides recognition patterns and provides a Recognition Bias Index by employing the validation unit (110). This index indicates possibility of favoritism/biasness in teams Human resource team can probe further to validate the same and prevent nepotism cases.

Case 3: Identify Disengaged Employees

All the employee interactions like login, recognition given, recognition received, participation in group events, posting and sharing updates and multiple other parameters are fed in system (100). The system (100) uses correlation and identifies individual that are disengaged and potential attrition candidates. The system (100) provides a Risk Index also assists in zeroing down list of high risk but star employees which organization should ideally try to positively engage.

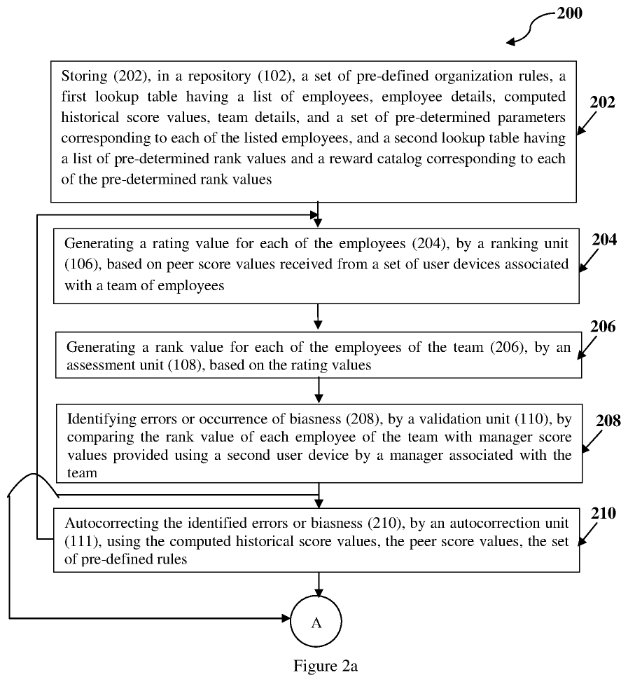

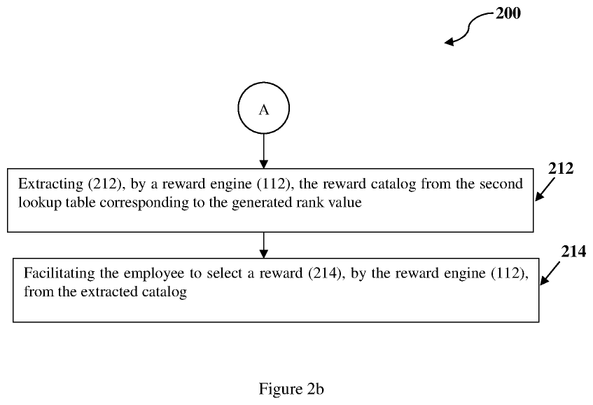

FIGS. 2a and 2b illustrate a flow diagram showing steps performed by the automated system (100). The method steps (200) are as follows:

At block (202), storing, in a memory (102), a set of pre-defined organization rules, a first lookup table having a list of employees, and employee details, computed historical score values, team details, corresponding to each of the listed employees, and a second lookup table having a list of pre-determined rank values and a reward catalog corresponding to each of the pre-determined rank values.

At block (204), generating a rating value for each of the employees, by a ranking unit (106), based on peer score values received from a set of user device (10) associated with a team of employees.

At block (206), generating a rank value for each of the employees of the team, by an assessment unit (108), based on the rating values.

At block (208), identifying errors or occurrence of biasness, by a validation unit (110), by comparing the rank value of each employee of the team with manager score values provided using a second user device by a manager associated with the team.

At block (210), autocorrecting the identified errors or biasness, by an autocorrection unit (111), using the computed historical score values, the peer score values, the set of pre-defined rules.

At block (212), extracting, by a reward engine (112), the reward catalog from the second lookup table corresponding to the generated rank value.

At block (214) facilitating the employee to select a reward, by the reward engine (112), from the extracted catalog.

Technical Advancements

The present disclosure provides a technical solution to a technical problem. Conventional rewarding/gifting techniques within organizations include giving random items as gifts, like decorative items, sweets, coupons/vouchers, and the like. For example, some organizations distribute confectioneries as gifts during festivals like Diwali/Dussehra, which may not appeal to a diabetic or health conscious employee. Further, the vouchers/coupons provided to him/her may never be used if the employee is not interested in the service that can be availed with the help of those vouchers/coupons. Moreover, such types of gifting techniques are private and provide limited or no recognition to the employee within his/her peers/superiors. Moreover, conventional rewarding techniques reward employees based on the ratings/scores/recognitions provided by the managers only. These conventional rewarding techniques are therefore prone nepotism which often leads to demotivation of team members which and can in turn result in less productivity thereby affecting overall growth of the organization.

The system as disclosed in the present disclosure provides an automated system for providing personalized rewards. The system as disclosed in the present disclosure facilitates objective ranking for rewarding employees by limiting biased ranking. Further, the system of the present disclosure also provides a platform that enables the managers to instantly reward the individuals from a team which invariably inculcates a sense of achievement in employees. Additionally, the system provides the human resource team of an organization with a tool that enables them in channelizing their efforts in a right direction and acting on issues that have potential to develop into demotivation and lack of interest of the unfavoured employees.

The system as disclosed in the present disclosure does not reward a particular employee based on his/her experience and tenure but automatically evaluate the employees based on their performance, historical information, and scores provided by their peer(s) and manager(s). Further, the system automatically detects error or biasness in rating of the employees and rectifies the detected error in rating using pre-defined rules so as to limit nepotism within the organization.

The system of the present disclosure employs a server having a ranking unit, an assessment unit, a validation unit, an autocorrection unit, and a reward engine. The server is configured to receive peer score values and the manager score values from the set of user devices and second user devices. Further, the server is configured to validate the recognitions/ranking provided by the manager by comparing the manager score values with peer score values. Upon successfully validating the recognition/ranking, the server allows the recognized employee to select a reward from a reward catalog, thereby maintaining a competitive environment within a team and keeping the employees of the team motivated.

The conventional methods of rewarding a particular employee do not disclose the aforementioned aspect of the present disclosure. The conventional methods only reply on the scores/ranking provided by the manager/appraiser and are therefore prone to errors and biasness.

The validation unit and the autocorrection unit, of the present disclosure, work in synchronization with the rewarding engine. The validation unit validates the manager score values based on the peer score values. The validation unit identifies the presence of at least one error or biasness by comparing the rank value of each employee, generated based on the peer score values, with the manager score values. Upon detecting error or biasness, the autocorrection unit autocorrects the identified errors or biasness by correcting the manager score values using the computed historical score values, the rating values computed using peer score values, and the set of pre-defined rules, thereby limiting biased ranking and rewarding. The conventional methods of rewarding are semi-automatic or manual wherein the user is required to manually rectify the errors detected by a validator which may lead to biasness. The system as disclosed in the present disclosure automatically validates, rectifies and notifies the user about presence of error(s) or biasness.

The system as disclosed in the present disclosure automatically recognizes the employees to be rewarded without any biasness. Since the system automatically recognizes the employees to be rewarded, the system as disclosed in the present disclosure is a high speed system which requires less execution time and is compatible with organizations of different sizes. The conventional methods are manual or semi-automatic which requires frequent human intervention and is therefore time consuming.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An automated system (100) for providing personalized rewards, said system (100) comprising:
a plurality of set of user devices (10), wherein each of said set of user devices is associated with a team of employees of an organization, each of said set of user devices (10) being configured to facilitate an employee of said associated team to provide at least one peer score value for each of the employees of said associated team based on a set of pre-defined parameters;
a plurality of second user devices (20), wherein each of said second user devices is associated with a manager of each of said teams, each of said second user device (20) being configured to facilitate said associated manager to provide a manager score value for each of the employees of said associated team respectively based on the set of pre-defined parameters; and
a server (30) configured to cooperate with said plurality of set of user devices (10) and said plurality of second user devices (20), said server (30) having:
a memory (102) configured to store a set of pre-defined organization rules, a first lookup table having a list of employees and employee details, computed historical score values, team details, corresponding to each of said listed employees, and a second lookup table having a list of pre-determined rank values and a reward catalog corresponding to each of said pre-determined rank values;
a ranking unit (106) configured to cooperate with said memory (102), said ranking unit (106) configured to generate a rating value for each of said employees based on said peer score values;
an assessment unit (108) configured to cooperate with said ranking unit (106), and further configured to generate a rank value for each of the employees of said team based on said rating values;
a validation unit (110) configured to cooperate with said assessment unit (108), and further configured to identify errors or an occurrence of biasness by comparing the rank value of each employee with said manager score values;
an autocorrection unit (111) configured to cooperate with said validation unit (110), said ranking unit (106), and said memory (102), said autocorrection unit (111) configured to autocorrect said identified errors or biasness by correcting said manager score values using said computed historical score values, said rating values computed using said peer score values and said set of pre-defined rules; and
a reward engine (112) configured to cooperate with said memory (102) and said assessment unit (108), and further configured to extract said reward catalog from said second lookup table corresponding to said generated rank value of each of said employees, said reward engine (112) configured to facilitate said employees to select a reward from said extracted catalog,
wherein said ranking unit (106), said assessment unit (108), said validation unit (110), said autocorrection unit (111), and said reward engine (112) are configured to be implemented using one or more processor(s).

2. The system (100) as claimed in claim 1, wherein said set of pre-determined parameters is selected from the group consisting of on-time project deliverables, discipline, attentiveness, punctuality, obedience to an organization policies, technical knowledge, productivity, and quality of work.

3. The system (100) as claimed in claim 1, wherein said autocorrection unit (111) comprises:
an updater (111a) configured to cooperate with said validation unit (110), and further configured to autocorrect said identified error by updating said manager score values said computed historical score values, said rating values computed using said peer score values and said set of pre-defined rules; and
a flag generator (111b) configured to cooperate with said updater (111a), and further configured to generate a flag to indicate autocorrection of said manager score values,
wherein, said flag generator (111b) and said updater (111a) are configured to be implemented using one or more processor(s).

4. The system (100) as claimed in claim 1, wherein said validation unit (110) is configured to generate an alert if biasness or error is identified.

5. The system (100) as claimed in claim 1, wherein said validation unit (110) comprises:
a comparator (110a) configured to compare the rank value of each employee, generated based on said peer score values, and said manager score values; and
an identifier (110b) configured to cooperate with said comparator (110a), and further configured to identify errors or biasness in said manager score values based on the comparison of the rank value of each employee with said manager score values,
wherein said comparator (110a) and said identifier (110b) are configured to be implemented using one or more processor(s).

6. The system (100) as claimed in claim 1, wherein said reward catalog contains rewards selected from the group consisting of gift vouchers, merchandise, cash coupons, sweets, chocolates, and e-vouchers.

7. The system (100) as claimed in claim 1, wherein said server (30) includes a communication module (116) configured to cooperate with said reward engine (112) to receive and transmit the extracted reward catalog to a user device associated with said employee.

8. The system (100) as claimed in claim 1, wherein said ranking unit (106) is configured to compute said rating value for each of said employees of said associated team by averaging said peer score values provided by the employees of said associated team for each of said employees.

9. The system (100) as claimed in claim 1, wherein said server (30) includes a dispatching unit (114) configured to cooperate with said memory (102) and said reward engine (112), and is further configured to dispatch the selected reward to a desired address of the employee.

10. A method (200) for providing personalized rewards, said method (200) comprising the steps of:
storing (202), in a memory (102), a set of pre-defined organization rules, a first lookup table having a list of employees, and employee details, computed historical score values, team details, corresponding to each of said listed employees, and a second lookup table having a list of pre-determined rank values and a reward catalog corresponding to each of said pre-determined rank values;
generating a rating value for each of said employees (204), by a ranking unit (106), based on peer score values received from a set of user devices (10) associated with a team of employees;
generating a rank value for each of said employees of said team (206), by an assessment unit (108), based on said rating values;
identifying errors or occurrence of biasness (208), by a validation unit (110), by comparing the rank value of each employee of said team with manager score values provided using a second user device by a manager associated with said team;
autocorrecting said identified errors or biasness (210), by an autocorrection unit (111), using said computed historical score values, said peer score values, said set of pre-defined rules;
extracting (212), by a reward engine (112), said reward catalog from said second lookup table corresponding to said generated rank value; and
facilitating said employee to select a reward (214), by said reward engine (112), from said extracted catalog.
